(19) United States
(12) Patent Application Publication
(10) Pub. No.: US 2009/0110920 A1
(43) Pub. Date: Apr. 30, 2009

(54) LAMINATE AND FRAMELESS DRY ERASE STRUCTURE MADE THEREFROM

(76) Inventor: Robert Bordener, Bloomfield Hills, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/930,574

(22) Filed: Oct. 31, 2007

(51) Int. Cl. B32B 17/10; B29C 65/00

(52) U.S. Cl. 428/339; 156/285; 156/60

(57) ABSTRACT

A laminate sheet for surfacing a dry erase board is provided. The laminate sheet has an upper sheet with a marking surface adapted to receive felt tip marker indicia and has a surface energy of less than 34 dynes per centimeter. A backing layer is provided on opposing surfaces each having a surface energy of more than 36 dynes per centimeter. A tie layer is provided intermediate between the upper layer and the backing layer that includes oblong or prolate particles. A dry erase marker board is formed from such a laminate sheet through applying the sheet to a substrate with an adhesive layer intermediate therebetween. The resulting dry erase marker board lacks a frame bounding the laminate sheet and ideally the laminate sheet wraps around the edges of a substrate.

### FIELD OF THE INVENTION

The present invention in general relates to a laminate structure and in particular to a frameless dry erase structure and a process for making the same with the laminate.

### BACKGROUND OF THE INVENTION

A dry erase marker board is characterized by a surface that receives ink or pigment in a solvated form and has a surface property such that the ink or pigment upon carrier solvent evaporation adheres to the dry erase surface. While solvent can occasionally be used for deep cleaning of such a marker board, typically the use of a dry cloth or dry eraser is sufficient to wipe the adhered pigment or ink from the board substrate. The prototypical dry erase substance is glazed porcelain. Unfortunately, porcelain is rigid, expensive, and not amenable to formation as a large board surface. As a result, dry erase substrates include coated papers or polymeric films adhered to a substrate. A surface layer of polypropylene is routinely used or other similar polymers on the basis of being nonporous so as to not absorb felt tip pen ink or pigment while having a surface energy such that felt tip markings adhere to the surface. While such papers or films laminated to an underlying substrate are routinely used, the resulting structure requires a frame bordering the whiteboard surface to protect the edges of the underlying substrate and inhibit delamination. The inclusion of a frame in a laminar dry erase board not only adds cost and complexity to the production process, but also limits design options.

Thus, there exists a need for a dry erase laminar structure produced in the absence of a bounding frame.

### SUMMARY OF THE INVENTION

A laminate sheet for surfacing a dry erase board is provided. The laminate sheet has an upper sheet with a marking surface adapted to receive felt tip marker indicia and has a surface energy of less than 33 dynes per centimeter. A backing layer is provided on opposing surfaces each having a surface energy of more than 30 dynes per centimeter. A tie layer is provided intermediate between the upper layer and the backing layer. The tie layer includes particles having dimensional asymmetry and a short axis less than 0.6 inches and an aspect ratio of more than 2. The particles have a preferential orientation with the long axis of the particles being parallel to the surfaces of the tie layer. The tie layer is of a thickness greater than the particle short axis thickness in this layer and typically between 5 and 2.5 mils. A dry erase marker board is formed from such a laminate sheet through applying the sheet to a substrate with an adhesive layer intermediate therebetween. The resulting dry erase marker board lacks a frame bounding the laminate sheet and ideally the laminate sheet wraps around the edges of a substrate. With the usage of a transparent or at least translucent upper sheet, the particles internal to the layer afford visual effects such as that of faux stone. Preferably, the layer contains multiple vertically displaced strata of particles to provide a visual effect of depth. More preferably the layer thickness accommodates three to five particle strata. It is appreciated that a particle loading of the tie layer exceeding 6 volume percent tends to give the tie layer and the resulting dry erase board a uniform visual appearance with a limited depth perception.

A process for forming a dry erase board from the laminate sheet involves the use of a scrim substrate and the application of a vacuum to the substrate, surface pressure, or a combination thereof. With the introduction of adhesive, the laminate sheet is drawn into binding contact with the substrate. The application of heat to the laminate sheet during the adherence process to the substrate so as to heat the laminate sheet ideally to a temperature between 170° and 300° Fahrenheit so as to thermally fit the sheet around the substrate. With the ability to encompass substrate edges with the laminate sheet, a dry erase board frame is specifically excluded from the marker board.

### BRIEF DESCRIPTION OF THE DRAWINGS

FIG. 1 is an exploded cross-sectional view of a inventive laminar coating and structure; and

FIGS. 2A-C are a schematic cross-sectional view of the stages associated with forming an inventive dry erase structure by a thermofoil process.

### DETAILED DESCRIPTION OF THE PREFERRED EMBODIMENTS

The present invention has utility as a laminar sheet having a dry erase external surface that is generally planar. The sheet is amenable to thermal processing so as to form a dry erase structure independent of a frame. The ability to provide an external dry erase surface absent a frame provides for the inclusion of a dry erase external surface on furniture, office partitions, displays, signs, tabletops, wallboard, and other home and office surfaces heretofore unsuitable for carrying a dry erase surface owing to the necessity of a frame.

As used herein a “mil” is defined as one-thousandth of an inch or 0.0254 millimeters.

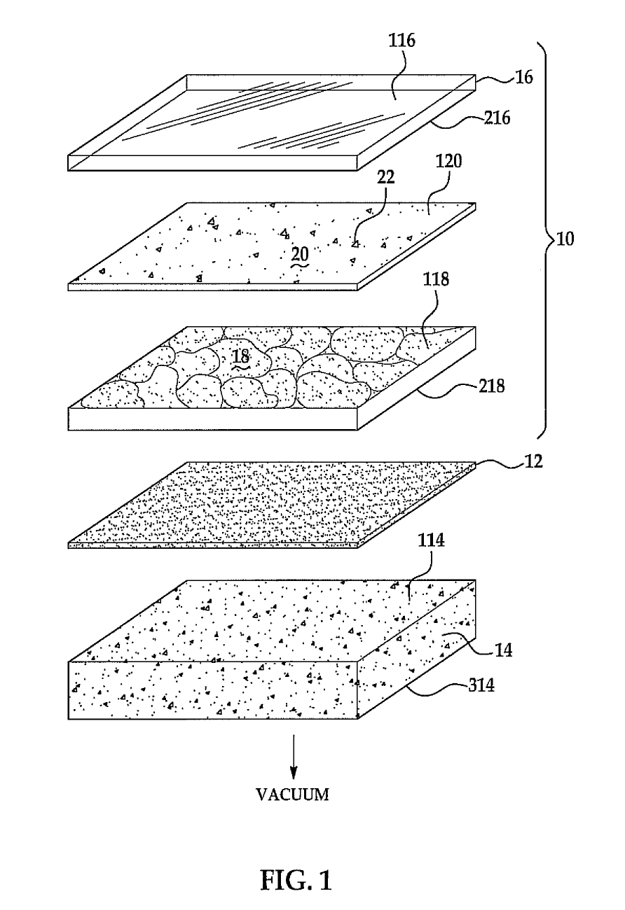

Referring to FIG. 1, an inventive laminate sheet is shown generally at 10. The laminate sheet 10 is shown overlying an adhesive 12 and a scrim substrate 14. A top layer 16 of the laminate sheet 10 is a dry erasable layer with a dry erasable upper surface 116 adapted to receive a felt tip pen markings and indicia. The marking surface 116 has a surface energy of less than 34 dynes per centimeter and preferably between 26 and 30 dynes per centimeter. Preferably, the surface energy of the marking surface 116 is an intrinsic characteristic of the upper layer 16 in an unmodified state. Materials from which an upper layer 16 is formed illustratively include polypropylene oxetane based polymers as detailed in U.S. Pat. No. 6,423,418, an aryl backbone epoxy, a polyurethane, a melamine resin, a polyester, a polyacrylate, a polymethacrylate, a blend of two or more thereof, or a block copolymer of two or more thereof. The upper layer 16 typically has a thickness of from about 0.25 to about 5 mils and preferably from about 0.75 to about 20 mils. More preferably, the upper layer 16 is more than 80% transparent to 550 nanometer wavelength light or translucent. It is appreciated that thermal processing of an inventive laminate sheet 10 is secured to an underlying scrim substrate 14 without resort to a frame using a thermal process is facilitated by the upper layer 16 having a high degree of polymer strand randomness. Thermal processing is facilitated by polymer strand orientation of less than 25% at 265° Fahrenheit.

The upper layer 16 optionally contains conventional additives such as pigments, dyes, color stabilizers, antioxidants, plasticizers, fillers, and flatting agents. Fillers such as silica are included within the upper layer 16 at loading levels of from 0 to 10 volume percent. Flatting agents are included to reduce the sheen of marling surface 116 and provide a matte finish. Typical flatting agents include colloidal silica, diatomaceous earth and wax. Depending on the nature of the flatting agent, these agents are typically present from 0 to about 3 total volume percent of the upper layer 16.

A backing layer 18 is provided having an outward surface 118 and an inward planar surface 218. The backing layer 18 is formed of a thermoset resin such as melamine, or polyester resin; paper such as Kraft paper; or a thermoplastic such as acrylonitrile butadiene styrene (ABS), acrylic, cellulose acetate, ethylene-vinyl acetate (EVA), fluoroplastics, polyacrylates (Acrylic), polyacrylonitrile, polyamide (PA or Nylon), polybutadiene (PBD), polycarbonate (PC), polyester, polyethylene (PE), polypropylene (PP), polystyrene (PS), and polyvinyl chloride (PVC). The backing layer 18 is characterized by surface energies on both surfaces 118 and 218 of above 36 dynes per centimeter. It is appreciated that in instances where the backing layer 18 is formed of paper, such as Kraft paper, the paper may be printed or embossed. Conventional printing techniques operative herein illustratively include gravure, lithography, dye sublimation, silk screening, flexography and the like. Thermoset or thermoplastic backing layer 18 is amenable to embossing to provide a texture discernable an the marking surface 116. The backing layer 18 typically has a thickness of between 3 and 40 mils.

The upper layer 16 is ideally retained in transparent or translucent form as is one or more optional tie layer 20 intermediate between the base surface 216 of upper layer 16 and outward surface 118 of backing layer 18 to provide a faux stone, faux metal, or other visual effect. Alternatively a layer 16 or 20 is pigmented or dyed to yield a uniform coloration. While only one tie layer 20 is depicted in FIG. 1, it is appreciated that multiple such layers are operative herein. The base surface 216 is adhered to an optional tie layer surface 120. The tie layer 20 preferably contains mica, cellophane, metal, metal oxide of other oblong particles having a longest axial dimension of less than 0.6 inches and an aspect ratio of at least 2. Preferably, the aspect ratio of the average particle is greater than 7 as measured between shortest axial distance of a particle relative to the longest axial distance of the same particle. Still more preferably, the aspect ratio is between 7 and 60. A tie layer 20 containing such flattened particles 22 is greater than the thickness of asymmetric particles embedded in the layer and typically has a thickness of between 1.5 and 25 mils. A tie layer 20 in each case is formed of a thermoplastic or thermoset resin as detailed above with respect to a backing layer 18. The tie layer 20 has surface energies on surfaces 120 and 220 of a value intermediate between that of marking surface 116 and outward surface 118 of backing layer 18. Typical surface energy values for surfaces 120 and 220 are between 35 and 45 dynes per centimeter.

The tie layer 20, in addition to being visually enhanced through the inclusion of particles 22, is also readily embossed to provide a texture discernable on marking surface 116. It is also appreciated that with the resin matrix of the tie layer 20 being transparent, multiple such tie layers 20 varying in particle size and/or identity are provided to yield a visual three-dimensional depth effect that exceeds the actual total thickness of the multiple tie layers 20. Alternatively, a single tie layer has graded particle density and/or identity through the thickness of the tie layer 20 to also provide a visual illusion of depth exceeding the actual thickness of the tie layer 20. Flattened particles 22 particularly well suited for arrangement in a tie layer 20 such that the long axis of a particle 22 extends parallel to the surface 120 illustratively include metal flake, flattened metal discs, mica, shredded sheeting, other chipped thermoplastic sheets, thermoset sheets, pigmented forms thereof dyed forms thereof, and combinations thereof. Laminated sheet 10 is formed by conventional laminating techniques illustratively including coextrusion of thermoplastic layers, extrusion of a thermoplastic layer into contact with an adjoining layer, and colamination. In order to facilitate lamination of disparate layers having different surface energies, base surface 216 is optionally exposed to a corona discharge, gas plasma, flame treatment, or a silane coupling agent.

A laminated sheet 10 is secured to a scrim substrate 14 by way of an intermediate contact adhesive layer 12. The adhesive 12 illustratively includes ethylene vinyl acetate (EVA), latex rubber, polyurethane, or other conventional adhesive. The scrim substrate 14 provides a rigid backing to support the laminated sheet 10. Suitable substrates 14 illustratively include particleboard, oriented strand board (OSB), plywood, steel, aluminum, polymeric sheeting, and the like with the proviso that the substrate 14 provides a desired level of rigidity to the dry erase board 1. In order to facilitate thermofoil or thermoforming processes, the substrate 14 is held in place through a fluid pressure applied to the rear surface 214 of the substrate 14 to create a vacuum suction on substrate surface 114 and substrate edges 314. The fluid pressure taking the form of an excess external pressure being exerted with a gas or liquid fluid media, or a reduced internal pressure being created between the substrate and the platen.

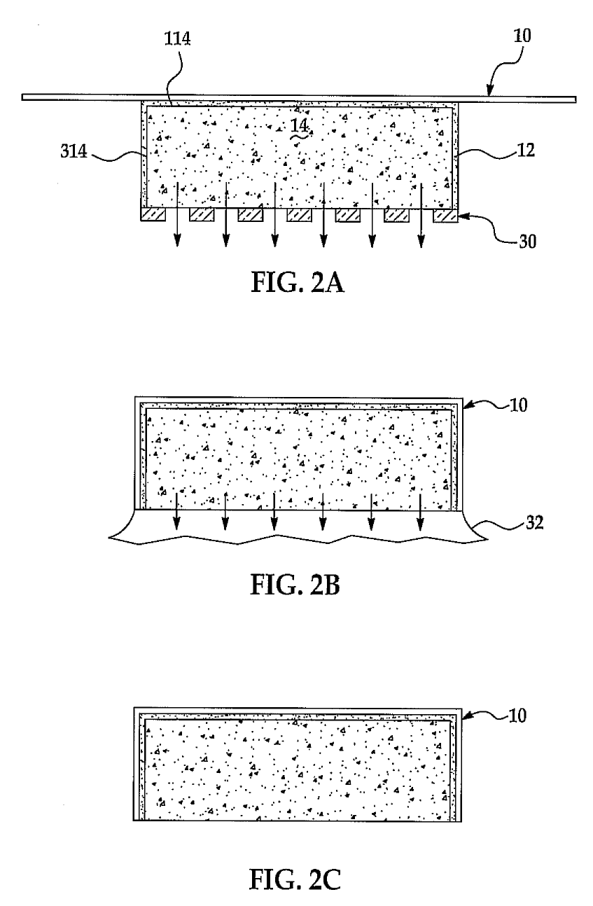

An inventive process for forming a frameless dry erase board increases the available making surface area while avoiding the complexity and costs associated with framing the resultant board 1. According to this process, a polymeric or wood-based scrim substrate is cut and otherwise shaped to a desired form. The inventive process is further illustrated with respect to FIGS. 2A-2C where like numerals correspond to those referenced with respect to FIG. 1. Scrim substrate 14 is placed on a platen 30 and a fluid pressure application, such as a vacuum drawn to secure the substrate 14 as denoted by arrows. An adhesive 12 is overlayered onto surface 114 and optionally onto edges 314. An oversized laminate sheet 10 is overlayered onto substrate 14 with adhesive 12 intermediate therebetween. The laminate 10 is drawn around to envelop substrate 14. With the application of a hot air stream to the laminate sheet 10 during the forming process as shown in FIG. 2B, laminate sheet 10 contracts to shrink wrap around the substrate 14. Optionally, the substrate 14 is also heated to facilitate the laminate sheet 10 wrapping around the substrate 14. Laminate sheet 10 is typically heated to a temperature between 170° and 350° Celsius to induce thermal contraction so as to form fit about the substrate 14. Subsequent to thermal processing, excess laminate sheeting 32 is trimmed from around the substrate 14 to yield a completed inventive dry erase board 1, as shown in FIG. 2C. Depending upon the temperature to which the laminate sheet is heated, the laminate sheet 10 can be made to conform to a texture or contours associated with the substrate 14 with high vacuum and temperature. Alternatively, a smooth suspended laminate sheet is attained with lower processing temperature to suspend the laminate sheet 10 over short-range contours associated with the substrate 10 typically having a peak-to-peak contour distance of less than 0.15 inches.

A particularly preferred laminate 10 has a polypropylene upper layer having a thickness of between 0.001 and 0.01 inches. The polypropylene is readily filled up to 40 weight percent with mineral filler particulate regardless of whether the filler is spherical or asymmetrical in shape. Typical filler loadings range from 0 to 40 weight percent and result in a coefficient of linear thermal expansion of less than 6×10⁻⁵ mm/mm ° C. The polypropylene is preferably secured by adhesive 12 to a PVC backing layer. More preferably, the PVC backing layer has a thickness of between 0.003 and 0.03 inches.

As a scrim substrate can be formed in any number of shapes and sizes, countertops, furniture, wall panels, cabinet surfaces and other complex forms of specialty fixtures are readily rendered as dry erase structures.

It is appreciated that laminate sheet 10 is readily shipped in sheet or roll form and optionally including a preapplied adhesive layer 12 with a peelable backing layer 34 so as to facilitate custom application at an installation site. Field installation is accommodated with the use of a heat gun and a vacuum platen.

The present invention is further illustrated with respect to the following nonlimiting examples.

### Example 1

A 3 mil thick film of propylene is laminated onto a 25 mil thick polyvinylchloride sheet with an intermediate heat activated EVA adhesive having a thickness of 2 mails. The resulting laminate sheet is placed over a preformed scrim of medium density fiberboard with an intermediate layer of EVA therebetween. The medium density fiberboard has a rounded edge to prevent tearing or damage to the laminate sheet. The scrim is subjected to thermofoil processing to yield a frameless dry erase board.

### Example 2

A 5 mil thick layer of polypropylene is coextruded with a 35 mil thick ABS backing layer containing particles having an average size of less than 0.6 inches and an aspect ratio of at least 2. The particles are pigmented thermoplastic film chips. An EVA adhesive is applied to the rearmost surface of the backing layer and adhered to a scrim substrate to provide a dry erase marker board with a granite-like decorative effect.

### Example 3

The process of Example 2 is repeated with the coextrusion of an intermediate tie layer therebetween, the tie layer inclusive of metallic flake particles. The tie layer is formed of polystyrene and has a thickness of 10 mils. The resultant laminate sheet is applied to a scrim as detailed in Example 1.

### Example 4

The laminate sheet of Example 3 is reproduced with exposed marking surface the polypropylene layer being embossed to provide a texture simulative of stone tile.

### Example 5

A layer of polypropylene is injection molded to a thickness of 0.02 inches and contains a percent by weight of hydrophobic closite clay to provide a coefficient of thermal expansion of less than 6×10⁻⁵ millimeters/millimeter-° Celsius and polymer strand orientation of less than 17% in both X and Y directions of the upper planar surface. The base surface is corona treated to yield a surface energy of 45 dynes per centimeter. The polypropylene sheet is laminated and applied to the substrate as detailed in Example 1.

### Example 6

The polypropylene sheet of Example 5 is reproduced with the inclusion of faceted titanium dioxide particulate having an average size of 3 microns to afford a bright white appearance to the resultant layer. The resultant layer is used in place of the propylene layer of Example 5 to yield a brightly white dry erase board.

### Example 7

The exposed marking surface of the dry erase board produced according to Example 6 is sanded to remove about 2 mils from the marking surface thereby exposing portions of filler thereby hardening the exposed surface with only nominal degradation of dry erase characteristics.

### Example 8

A 1 mil thick layer of polypropylene having an orientation of polymeric strands exceeding 50% in the X direction of the sheet is overlaid onto the propylene sheet of Example 7 with the difference that the low orientation polypropylene sheet has a thickness of 14 mils and is filled with 3 volume percent of crushed magnesium silicate having an average diameter of 0.9 microns. A 10 mil thick film of EVA is colaminated onto the rear surface of 14 mil thick low orientation polypropylene. The resultant laminate sheet is stored for 4 months in a warehouse and with no additional adhesive run through a pinch roller and bonded to a sheet of smooth plywood with a polyurethane-based adhesive.

### Example 9

The procedure of Example 8 is repeated with usage of a polyurethane glue and the absence of the EVA film, to yield an operative inventive laminate sheet.

### Example 10

The procedure of Example 8 is repeated with usage of a polypropylene top layer having a thickness of 2 mils, a tie layer of EVA having a thickness of 3 mils, and backing layer of Kraft paper. The resultant laminate sheet is stored for 4 months in a warehouse and with no additional adhesive run through a pinch roller and bonded to a sheet of smooth plywood with a polyurethane-based adhesive to yield a universal marker board suitable for panels, walls, and the like.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A laminate sheet for surfacing a dry erase board comprising:
an upper layer having a marking surface and a base surface, the marking surface having a marking surface surface energy of less than 34 dynes per centimeter;
a backing layer having an outward surface and an inward surface, the outward surface having an outward surface surface energy of greater than 36 dynes per centimeter and the inward surface having an inward surface surface energy of greater than 36 dynes per centimeter;
a thermoplastic tie layer intermediate between said upper layer and said backing layer, said tie layer having a tie layer thickness; and
a plurality of particles each having a long axis less than 0.6 inches and a short axis and define an aspect ratio of greater than 2 where the short axis is less than the tie layer thickness.

2. The sheet of claim 1 wherein said upper layer is polypropylene.

3. The sheet of claim 1 wherein said upper layer has a thickness of between 0.75 and 20 mils.

4. The sheet of claim 1 wherein the base surface of said upper layer has a base surface surface energy of greater than 36 dynes per centimeter.

5. The sheet of claim 4 wherein the base surface surface energy is produced through exposing the base surface to a treatment selected from the group consisting of: a corona discharge, a flame, and a silane coupling agent.

6. The sheet of claim 1 wherein said backing layer is Kraft paper.

7. The sheet of claim 1 wherein said backing layer is polyvinylchloride.

8. The sheet of claim 1 wherein said tie layer has a thickness of between 1.5 and 25 mils.

9. The sheet of claim 1 wherein said plurality of particles have an aspect ratio of greater than 7.

10. The sheet of claim 1 wherein said plurality of particles is of a type selected from the group consisting of: metal flake, compressed metal particles, mica chips, shredded polymeric film, and combinations thereof.

11. A dry erase marker board comprising:
a substrate;
a laminate sheet for surfacing a dry erase board comprising:
an upper layer having a marking surface and a base surface, the marking surface having a marking surface surface energy of less than 34 dynes per centimeter; and
a backing layer having an outward surface and an inward surface, the outward surface having an outward surface surface energy of greater than 36 dynes per centimeter and the inward surface having an inward surface surface energy of greater than 36 dynes per centimeter overlying said substrate; and
an adhesive intermediate between said substrate and said laminate sheet wherein the marker board is independent of a frame encompassing the laminate sheet.

12. The board of claim 11 wherein said substrate is a scrim.

13. The board of claim 11 wherein said substrate has an edge that is rounded.

14. The board of claim 13 wherein said laminate sheet wraps around the edge.

15. The board of claim 11 further comprising a plurality of particles each having a long axis less than 0.6 inches and a short axis and defile an aspect ratio of greater than 2 in at least one of said upper layer and said lower layer.

16. A process for forming a marker board comprising:
placing a scrim substrate in contact with a vacuum platen;
contacting a surface of said scrim substrate with an adhesive;
applying a fluid pressure through said platen;
overlying laminate sheet for surfacing a dry erase board comprising:
an upper layer having a marking surface and a base surface, the marking surface having a marking surface surface energy of less than 34 dynes per centimeter; and
a backing layer having an outward surface and an inward surface, the outward surface having an outward surface surface energy of greater than 36 dynes per centimeter and the inward surface having an inward surface surface energy of greater than 36 dynes per centimeter onto said adhesive; and
discontinuing said fluid pressure.

17. The process of claim 16 further comprising heating said laminate sheet simultaneous with the drawing of the vacuum.

18. The process of claim 16 wherein said laminate sheet is oversized relative to said substrate and encompasses a substrate edge.

19. The process of claim 16 further comprising sanding a marking surface of said laminate sheet.

20. The process of claim 16 wherein said upper layer is polypropylene.

21. The process of claim 20 wherein said backing layer is polyvinyl chloride.

22. The process of claim 20 wherein said polypropylene has an upper layer thickness of between 0.001 and 0.01 inches.

23. The process of claim 20 wherein said polypropylene comprises 10 to 40 weight percent mineral particulate to yield a filled polypropylene.

24. The process of claim 21 wherein said polyvinyl chloride has a backing layer thickness of between 0.003 and 0.03 inches.

25. The process of claim 23 wherein said filled polypropylene has a coefficient of thermal linear expansion of less than 6×10⁻⁵ mm/mm ° C.
